(19) United States
(12) Patent Application Publication
(10) Pub. No.: US 2013/0090110 A1
(43) Pub. Date: Apr. 11, 2013

(54) MANAGING BATTERY POWER USAGE OF A LOST MOBILE DEVICE TO EXTEND SEARCH TIME FOR THE LOST MOBILE DEVICE

(71) Applicants: Thomas Cloonan, Lisle, IL (US); Charlena Thorpe, Suwanee, GA (US)

(72) Inventors: Thomas Cloonan, Lisle, IL (US); Charlena Thorpe, Suwanee, GA (US)

(21) Appl. No.: 13/270,398

(22) Filed: Oct. 11, 2011

(51) Int. Cl. H04W 24/00; H04W 4/00; H04W 4/14; G08B 5/22

(52) U.S. Cl. 455/420; 340/8.1; 455/456.1

(57) ABSTRACT

Methods and apparatuses are provided to use energy reduction techniques in an effort to extend the battery life of a mobile device when the mobile device is lost to increase the time an owner of a lost mobile device has to search for the lost device using any lost mobile device locating technique before the mobile device's battery fully discharges. A lost mobile device receives a power preservation command and operates in a power preservation mode while executing a locating technique to aid in the locating the lost mobile device.

### TECHNICAL FIELD

This disclosure relates to mobile devices.

### BACKGROUND

Mobile phones appear to be reaching near ubiquitous status with, according to some statistics, 5.3 billion mobile subscribers worldwide (i.e., 77 percent of the world population) and over 90% of the global population having access to mobile networks. Not only has mobile phone use increased significantly over the last two decades, mobile phone features and capabilities have increased as well. For example, mobile phone capabilities can go beyond the basic functionality of receiving and placing calls and sending and receiving text messages; modern mobile phones can, among other things, browse the Web, play music and videos, take and send photos and videos, provide GPS navigation, provide wireless communications (e.g., Wi-Fi™ and Bluetooth®), provide high resolution screens, and download and run a large library of applications including games.

The growing popularity of mobile phones over the years can be attributed, at least in part, to their shrinking size. Unfortunately, because of their small size, among other things, mobile phones can be easily misplaced. One technique used by mobile phone owners to locate a lost mobile phone involves calling the mobile phone, for example, from another phone or via a Web-based application, to cause the mobile phone to emit an audible sound in an effort to locate the phone. Other techniques, for example, use the GPS functionality of the phone to attempt to locate the phone. For example, when a phone is prompted remotely (for example via a Short Message Service (SMS) message sent to the phone), the phone will send (for example in a return SMS message) the GPS coordinates, for example, of the phone.

None of the existing techniques to locate a lost mobile phone (“lost phone locating techniques”) will work if the mobile phone's battery power is fully discharged. Unfortunately, because there are more services consuming the battery power of the modern mobile phone, the battery life of a mobile phone can be limited. Thus, an owner of a lost phone may have a limited amount of time to use a lost phone locating technique to locate a lost mobile phone before the battery fully discharges due to normal operation of the phone. Once the battery is fully discharged, none of the existing lost phone locating techniques will work.

### BRIEF DESCRIPTION OF THE DRAWINGS

FIG. 1 is a block diagram illustrating an example process for extending the battery life of a lost mobile phone to increase the time available to search for the lost phone using any lost phone locating technique.

FIG. 2 is a block diagram illustrating an example implementation of a mobile phone operable to perform the example process of FIG. 1.

### DETAILED DESCRIPTION

Various implementations of this disclosure use energy reduction techniques in an effort to extend the battery life of a mobile device when the mobile device is lost. In this way, the time an owner of a lost mobile device has to search for the lost device using any lost mobile device locating technique can be extended before the mobile device's battery fully discharges.

Although this disclosure makes reference to mobile phones, this disclosure is not intended to be limited to mobile phones. It should be understood that the concepts disclosed herein can be applied to any portable device that can be accessed remotely including, but not limited to, connected mobile device such as mobile phones, tablets, netbook or notebook computers, and two-way radio transceivers, and wireless devices such as wireless meters, for example.

Further, this disclosure is not limited to any particular lost mobile device locating technique. Any existing or future developed locating technique is intended to be included within the scope of this disclosure.

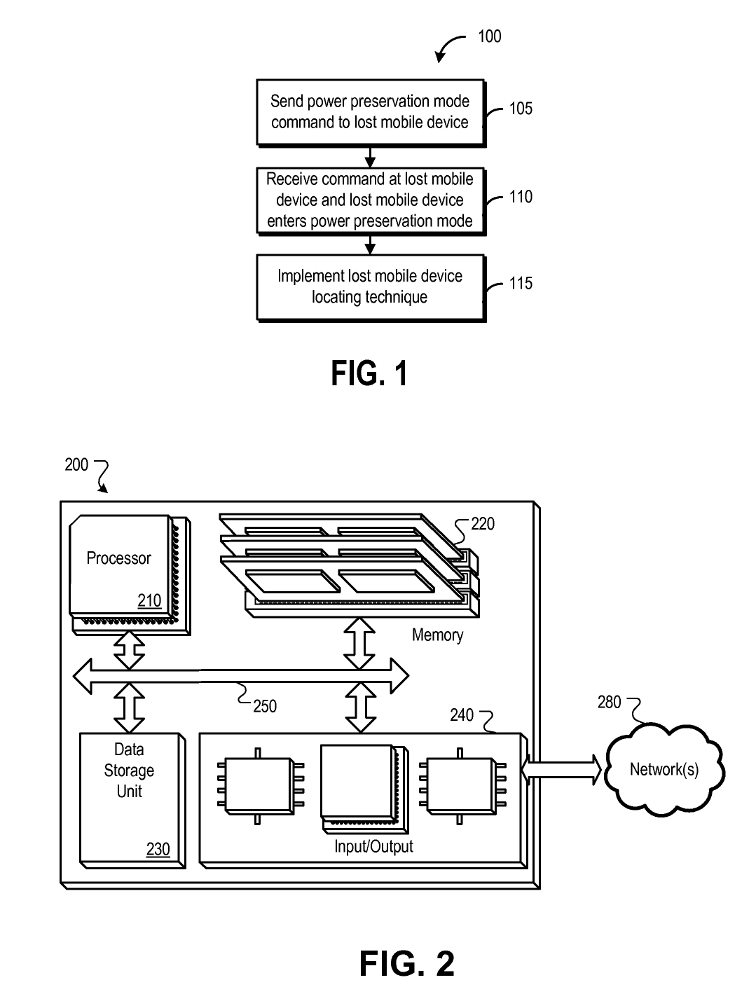

FIG. 1 illustrates an example process 100 for extending the battery life of a lost mobile device, such as a mobile phone, to increase the time available to search for the lost mobile device using any lost mobile device locating technique.

At stage 105, an owner of a lost mobile device sends a command to the mobile device to enter a power preservation mode. For example, for a lost mobile phone, the owner can send the command from another phone via a SMS text message or telephone call or from a computer via an email message or Web application. For example, the power preservation mode command can be in the form of a formatted text message that can include a command code for the power preservation mode and a security code to ensure that the sender of the command is an authorized sender. As another example, the owner could call the lost mobile phone from another phone and then enter a command code and security code using the keypads on the phone. One of ordinary skill in the art would know how to send a command to a mobile device such as a mobile phone. This disclosure is not limited to any particular method for remotely commanding a mobile device. Any existing or future developed technique for remotely commanding a mobile device such as a mobile phone is intended to be included within the scope of this disclosure.

In some implementations, the command sent at stage 105 also can identify the intended lost mobile device locating technique to be used. For example, for a lost mobile phone, if the owner of the lost phone knows the approximate vicinity of the phone, the owner can decide to use a calling method (e.g., a method that calls the lost phone or otherwise emits an audible sound from the lost phone) to locate the lost phone. The command sent at stage 105 can specify a calling method as the lost phone locating technique to be used. On the other hand, for example, if the phone might be in a larger geographical area, then a GPS-based method (e.g., a method that uses the GPS functionality of the phone) may be more appropriate. Thus, the command set at stage 105 can identify a GPS-based method as the lost phone locating technique to be used.

At stage 110, the lost mobile device receives and processes the power preservation mode command and enters a power preservation mode. By entering the power preservation mode at the instant of receiving the command, the time to locate the lost mobile device can be maximized before the battery fully discharges.

In some implementations, the lost mobile device may not enter a power preservation mode immediately upon receiving the power preservation mode command; instead, the lost mobile device may wait until its battery power has reached a predetermined level before operating in a power preservation mode. In this way, the mobile device (such as a mobile phone) can operate normally until the battery power has reached the predetermined level and then enter a power preservation mode.

As discussed above, because there are more services on a modern mobile phone consuming the battery power, the battery life of a mobile phone can be limited. Techniques to reduce the power consumed by a mobile phone to preserve power and extend the battery life include, but, are not limited to, disabling Wi-Fi™, Bluetooth®, and/or GPS functionalities, disabling synchronization and updating functionalities/applications, disabling downloaded applications, disabling the phone from receiving calls or ringing or vibrating, disabling the phone from sending or receiving data, changing the network mode (e.g., from 3G to 2G), and reducing the brightness setting on the phone.

For a mobile phone, for example, a power preservation mode can be based on a specified lost phone locating technique to be used. That is, a power reservation mode can disable as many applications/functionalities as it can except for those needed to implement the identified lost phone locating technique. For example, if at stage 105, it is indicated that a calling method would be used to locate the phone, then the phone could disable all applications/functionalities of the phone (in some implementation, SMS, for example, may still be operational for the phone to receive future commands) and periodically emit a sound. In some implementations, the phone could emit the sound until it receives a cancel command (e.g., via SMS) or until a predetermined period has elapsed. Alternatively, the phone could disable all phone operations except the receive call and ring functionalities and ring the phone if a call is from a predetermined number.

As another example, if at stage 105, it is specified that a GPS-based method would be used to locate the phone, then the phone may not disable the GPS and SMS functionalities of the phone. In this way, the phone could determine its location and send GPS coordinates, for example, via SMS to a predetermined phone, for example.

At stage 115, a lost mobile device locating technique can be implemented. As discussed above, this disclosure is not limited to any particular lost mobile device locating technique. Any existing or future developed lost mobile device locating technique is intended to be included within the scope of this disclosure.

FIG. 2 illustrates an example mobile device 200 operable to perform stages 110 and 115 of the example process 100 of FIG. 1. The mobile device 200 can include a processor 210, a memory 220, a data storage unit 230 (e.g., the data storage unit can be either fixed or removable), and an input/output device 240. Each of the components 210, 220, 230, and 240 can, for example, be interconnected using a system bus 250. In some implementations, the mobile device 200 can include one of more interconnected boards where each board comprising components 210, 220, 230, and 240.

The processor 210 is capable of processing instructions for execution within the mobile device 200. For example, the processor 210 can be capable of processing instructions for executing stages 110 and 115 of the process 100 of FIG. 1. In some implementations, the processor 210 is a single-threaded processor. In other implementations, the processor 210 is a multi-threaded processor. The processor 210 can be capable of processing instructions recorded in the memory 220 or on the storage unit 230.

The memory 220 stores information within the mobile device 200. In some implementations, the memory 220 is a computer-readable medium. In other implementations, the memory 220 is a volatile memory unit. In still other implementations, the memory 220 is a non-volatile memory unit.

In some implementations, the storage unit 230 is capable of providing mass storage for the mobile device 200. In one implementation, the storage unit 230 is a computer-readable medium. In some implementations, the storage unit 230 is not removable. In various different implementations, the storage unit 230 can, for example, include a hard disk device, an optical disk device, flash memory or some other large capacity storage device.

The input/output device 240 provides input/output operations for the mobile device 200. In one implementation, the input/output device 240 can include one or more of a wireless interface, WAN/LAN network interface, such as, for example, an IP network interface device, e.g., an Ethernet card, a cellular network interface, a serial communication device, e.g., and RS-232 port, and/or a wireless interface device, e.g., an 802.11 card. In another implementation, the input/output device 240 can include driver devices configured to receive input data and send output data to other input/output devices, as well as sending communications to, and receiving communications from various networks.

Implementations of the device of this disclosure, and components thereof, can be realized by instructions that upon execution cause one or more processing devices to carry out the processes and functions described above. Such instructions can, for example, comprise interpreted instructions, such as script instructions, e.g., JavaScript or ECMAScript instructions, or executable code, or other instructions recorded in a computer readable medium.

The processes and logic flows described in this specification can be performed by one or more programmable processors executing one or more computer programs to perform functions by operating on input data and generating output thereby tying the process to a particular machine (e.g., a machine programmed to perform the processes described herein). The processes and logic flows can also be performed by, and apparatus can also be implemented as, special purpose logic circuitry, e.g., an FPGA (field programmable gate array) or an ASIC (application specific integrated circuit).

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD ROM disks. The processor and the memory can be supplemented by, or incorporated in, special purpose logic circuitry.

While this specification contains many specific implementation details, these should not be construed as limitations on the scope of any invention or of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Particular implementations of the subject matter described in this specification have been described. Other implementations are within the scope of the following claims. For example, the actions recited in the claims can be performed in a different order and still achieve desirable results, unless expressly noted otherwise. As one example, the processes depicted in the accompanying figures do not necessarily require the particular order shown, or sequential order, to achieve desirable results. In some implementations, multitasking and parallel processing may be advantageous.

1. A method for extending the battery life of a lost mobile device to increase the time available to search for the lost mobile device using a lost mobile device locating technique, the method comprising:
receiving at a lost mobile device a power preservation mode command;
operating the lost mobile device in a power preservation mode; and
executing a lost mobile device locating technique to aid in locating the lost mobile device.

2. The method of claim 1 wherein the lost mobile device is a mobile phone.

3. The method of claim 1 wherein the lost mobile device is a mobile computer.

4. The method of claim 1 wherein the lost mobile device is a wireless meter.

5. The method of claim 1 wherein receiving at a lost mobile device a power preservation mode command comprises receiving wirelessly at a lost mobile device a power preservation mode command.

6. The method of claim 2 wherein the power preservation mode command is received via SMS.

7. The method of claim 2 wherein the power preservation mode command is received via a phone call.

8. The method of claim 1 wherein the power preservation mode command is generated and received when the battery power level of the lost mobile device reaches a predetermined level.

9. The method of claim 1 wherein the power preservation mode command includes a security code.

10. The method of claim 1 wherein the power preservation mode command includes information on the lost mobile device locating technique.

11. The method of claim 1 wherein operating the lost mobile device in a power preservation mode comprises disabling one or more functionalities of the mobile device.

12. The method of claim 1 wherein operating the lost mobile device in a power preservation mode comprises operating the lost mobile device in a power preservation mode based on the lost mobile device locating technique.

13. The method of claim 1 wherein executing a lost mobile device locating technique to aid in locating the lost mobile device comprises emitting an audible sound from the lost mobile device.

14. The method of claim 1 wherein executing a lost mobile device locating technique to aid in locating the lost mobile device comprises transmitting a location for the lost mobile device.

15. A mobile device comprising:
computer readable medium having instructions for causing a computer to execute a method for extending the battery life of a lost mobile device to increase the time available to search for the lost mobile device using a lost mobile device locating technique, the method comprising:
operating the lost mobile device in a power preservation mode upon receiving a power preservation mode command; and
executing a lost mobile device locating technique to aid in locating the lost mobile device.

16. A mobile device comprising:
means for receiving at a lost mobile device a power preservation mode command;
means for operating the lost mobile device in a power preservation mode; and
means for executing a lost mobile device locating technique to aid in locating the lost mobile device.
